(19) United States
(12) Patent Application Publication
(10) Pub. No.: US 2008/0295895 A1
(43) Pub. Date: Dec. 4, 2008

(54) WATER LEAKAGE AND FAULT SENSING SYSTEM

(76) Inventors: Raymond A. Vincent, Plymouth, MI (US); Mark M. Mrocca, Belleville, MI (US); John Abbott, Westland, MI (US); Jeffrey Iott, Monroe, MI (US)

Correspondence Address: Masco Corporation, 21001 Van Born Road, Taylor, MI, 48480, US

(21) Appl. No.: 11/755,023

(22) Filed: May 30, 2007

(51) Int. Cl. F16L 5/00

(52) U.S. Cl. 137/357; 137/487.5

(57) ABSTRACT

A system is provided for monitoring leakage within a building. Remote sensors are placed at locations that are likely to have leaks occurring. If a leak is detected by one of the remote sensors, a signal is sent to a control for a main shut-off valve. The main shut-off valve is placed on the main water supply line leading into the building. Further, a flow meter is placed on the main water supply line. The flow meter monitors water being delivered into the building, and should an abnormal water flow be detected, the control will close the shut-off valve. The flow meter and control may learn normal water usage patterns for the building, or the patterns may be pre-programmed into the system. A manual override allows the control to be bypassed when it is intended for a large volume of water to be moved into the building, such as when a swimming pool is filled, etc.

### BACKGROUND OF THE INVENTION

This application relates to a water leakage and fault sensing system wherein sensors sense leakage in various locations within a building, and further the water usage is monitored to determine abnormal water usage patterns. If a problem is identified, then a main shut-off stops water flow to the building.

Buildings utilize water in a variety of locations. Items which use water, such as tubs, pools, washing machines, etc. can sometimes leak. Further, water flow lines can break, causing catastrophic leakage.

Various methods have been proposed in the prior art to monitor for such fault or leakage. One general type of prior art system monitors the flow volume through the system, and looks for sudden increases. Those sudden increases may be interpreted as resulting from a leak. Another general type of system utilizes leakage sensors at locations within the building. If the leakage sensors sense leakage, a remote signal is sent to a shut-off valve. These two general features have not been utilized in combination. Moreover, the prior art has generally not been provided with the ability to override these control features.

### SUMMARY OF THE INVENTION

In the disclosed embodiment of this invention, a shut-off valve for a main water supply line to a building is provided with remote signals from leakage sensors. If leakage is detected within the building, signals are sent to a control, and the shut-off valve can be closed.

Further, the same system incorporates a flow meter that monitors water usage. The general water use patterns within the building may be learned by the control, or the control may simply look for pre-programmed abnormalities.

In another feature of this invention, a manual override is provided to the control. This allows intended “abnormal” water usage, such as may occur when filling a pool, etc.

These and other features of the present invention can be best understood from the following specification and drawings, the following of which is a brief description.

### BRIEF DESCRIPTION OF THE DRAWINGS

FIG. 1 is a schematic view of the inventive system.

FIG. 2 is a flowchart of the invention.

### DETAILED DESCRIPTION OF THE PREFERRED EMBODIMENT

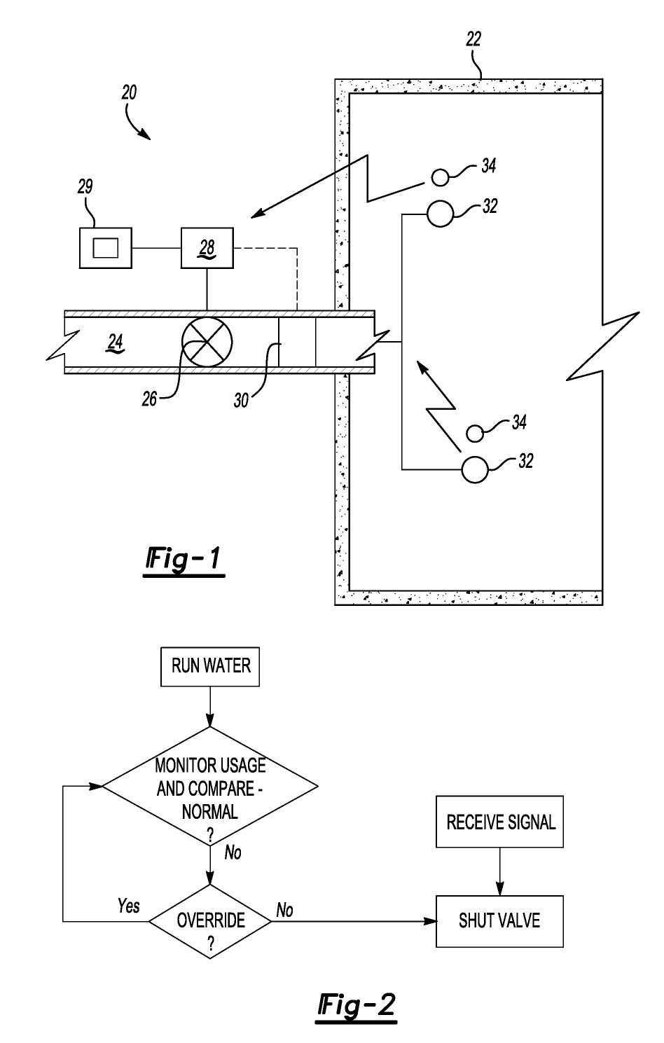

A water monitoring system 20 is illustrated in FIG. 1. System 20 includes a mains water supply line 24 leading to a building 22. A shut-off valve 26 is placed on the main water supply line 24. A control 28 for the shut-off valve 26 receives a signal from a flow meter 30. Flow meter 30 is a proportional flow meter, and monitors water usage. Either the flow meter 30 or the control 28 may learn regular water usage patterns for the building 22, or may be pre-programmed to identify particular usage patterns that may be expected. Deviation from these expected patterns, i.e., an increase in flow, may be indicative of a leak.

A manual override switch 29 allows manual override of this control 28 to allow intended “abnormal” usage such as filling a pool, etc.

Remote locations 32 may be provided with remote leakage sensors 34 that are able to communicate through an RF or other wireless connection to the control 28. Sensors 34 are preferably placed at locations where a leak might most likely occur. For example, the vicinity of an outside pipe which could break in the winter, the location of a tub, dishwasher, washing machine, etc. would be likely locations for inclusion of a sensor 34.

The present invention thus incorporates both the flow monitoring and the leakage-sensing concept into a single system. Further, by learning water usage patterns for the building, the system is more accurate with regard to identifying leaks, and eliminating false leaks. In addition, manual override switch 29 also eliminates a source of unintended shutdown of the shut-off valve 24. Of course it would be undesirable to have the water supply to a building improperly shutdown, and thus making the system more accurate is a beneficial step.

FIG. 2 shows a flowchart of the inventive control. The inventive control algorithm 28 may be set to “learn” normal usage patterns over the first few months after it has been installed in the building, or it may also be programmed with ranges of normal use for the particular type of building. Deviation from this normal usage by a predetermined amount which would be indicative of a potential leak, and the control would thus shut the valve 26.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A water supply system for a building comprising:
a main water supply line;
a shut-off valve mounted on said main water supply line, said shut-off valve having a control, said control receiving a signal from a flow meter; and
a plurality of leakage sensors located at various locations within the building, said leakage sensors sending a signal to said control, said control being operable to receive said signals from said leakage sensors and from said flow meter, and determine whether a leak is occurring within the water supply system, said control operable to close said shut-off valve if a determination is made that a leak is occurring.

2. The water supply system as set forth in claim 1, wherein said sensors send wireless signals to said control.

3. The water supply system as set forth in claim 1, wherein said flow meter is positioned directly downstream of said main shut-off valve.

4. The water supply system as set forth in claim 1, wherein said flow meter is utilized to generate and store normal water usage patterns in the building, and said normal water usage patterns being compared to monitored water usage to determine whether a leak is occurring.

5. The water supply system as set forth in claim 1, wherein a manual override switch allows the control to be manually overridden, such that large volumes of water can be moved without a shutdown of the shut-off valve.

6. A water supply system for a building comprising:
a main water supply line;
a shut-off valve mounted on said main water supply line, said shut-off valve having a control, said control receiving a signal from a flow meter mounted downstream of said main water supply line;
a plurality of leakage sensors located at various locations within the building, said leakage sensors sending a wireless signal to said control, said control being operable to receive said signals from said leakage sensors and from said flow meter, and determine whether a leak is occurring within the water supply system, said control operable to close said shut-off valve if a determination is made that a leak is occurring;
said flow meter utilized to generate a memory of normal water usage patterns in the building, and said normal water usage patterns being compared to monitored water usage to determine whether a leak is occurring; and
a manual override switch allowing the control to be manually overridden, such that large volumes of water can be moved without a shutdown of the shut-off valve.

7. A method of controlling water flow into a building comprising the steps of:
(1) providing a shut-off valve on a main water supply line to a building;
(2) providing remote sensors at various locations within the building, said remote sensors being operable to sense leakage and send a signal to a control for said shut-off valve;
(3) providing a flow meter, said flow meter communicating with said control; and
(4) sending water usage information from said flow meter to said control and comparing current water usage to normal water usage, and identifying a leak if said current water usage differs substantially from said normal water usage, and sending signals from said remote sensors to said control if said remote sensors sense leakage within the building.

8. The method as set forth in claim 7, wherein said flow meter and said control learn normal water usage patterns for the building which are then utilized as said normal water usage.

9. The method as set forth in claim 7, wherein a manual override is provided for manually overriding the control and allowing large volumes of water to be delivered into the building.
